(19) United States
(12) Patent Application Publication
(10) Pub. No.: US 2026/0150776 A1
(43) Pub. Date: Jun. 4, 2026

(54) A PLANT SEED WITH A COATING AND A METHOD OF COVERING A SEED WITH A COATING

(71) Applicant: Enza Zaden Beheer B.V., Enkhuizen (NL)

(72) Inventors: Rob Abbestee, Enkhuizen (NL); Sacha Souverein-Kofman, Enkhuizen (NL); Minako Kaneda, Hoorn (NL); Nancy Tamashiro-Takano, Zutphen (NL)

(21) Appl. No.: 19/111,507

(22) PCT Filed: Sep. 11, 2023
(86) PCT No.: PCT/EP2023/074885

§ 371 Date: Mar. 13, 2025

(30) Foreign Application Priority Data
Sep. 14, 2022 (NL) 2033024

(51) Int. Cl. A01C 1/06

(52) U.S. Cl. CPC A01C 1/06

(57) ABSTRACT

The present disclosure relates to a composition for coating of organically grown plant seeds and its use for improving the germination of plant seeds. The present disclosure further relates to a seed coating for a plant seed comprising a composition and a method for coating of plant seeds and for improved seed germination of organically grown plant seeds.

### RELATED APPLICATIONS

This application is a U.S. National Phase of International Patent Application No. PCT/EP2023/074885 filed Sep. 11, 2023, which claims priority to Dutch Patent Application No. 2033024 filed Sep. 14, 2022, the content of each of which is incorporated herein by reference in its entirety.

### DESCRIPTION

The present invention relates to a plant seed comprised of a coating composition for coating of organically grown plant seeds. The present invention furthermore relates to the use for improving the germination of plant seeds by coating plant seeds with a coating composition and a method for coating of plant seeds and for improved seed germination of organically grown plant seeds.

Many plant seeds are primed and pelleted before these are made commercially available. Seed priming is performed by regulating the seed moisture content, and the temperature for a specific amount of time. One of the goals of priming a batch of seed is to bring all seeds at the same level of development, close to the point of germination. Seed priming enables a fast and uniform emergence of the plant after the seed is planted. A further goal of priming can be to break both photo- and thermo-dormancy, which allows the seed to germinate in the dark and at higher temperatures. In addition to, or alternatively to priming, seeds are often pelleted or film coated or dusted with materials, wherein the seed is covered with materials to improve handling, more specifically sowability, protection, and plant establishment. “Pelleting”, “film coating” and “dusting” are each examples of “coating” as used herein.

Agents used for germinating seed usually contain peat, which is widely used in both professional and hobby horticulture. However, peat production is affecting the environment since it is harvested from so called peatlands, which represent a massive store of soil carbon. If drained or harvested, the carbon is released into the atmosphere. From drainage alone, the EU's peatland-related emissions amount to about 270 Mt CO₂ per year. Due to the negative environmental effects linked to peat, the EU has decided to gradually decrease the harvesting and usage of peat, and that peatlands are being used as forest land, cropland or grazing land. Therefore, especially in organic substrates, because of requirements of the customer and organic organizations, peat is likely to be replaced more and more by green compost, and wood fibre or coco.

Green compost can be added in the manufacture of substrates, usually to at least partially replace peat, in order to get a good soil life for the mineralisation of the organic fertilizer, as well as to suppress the effects of soil borne diseases. This green compost, however, may also possess a risk with respect to the fact that micro-organisms present in the compost or the presence of (unknown) substances in this green compost, may hinder the germination. Some micro-organisms in the green compost may be pathogenic or they may produce substances that hinder the germination.

Plant seeds of important food crops, for example lettuce seeds, have problems when germinated in organic substrates, especially those containing compost. Organically grown or production refers to production that integrates cultural, biological (non-GMO, reduced use or no use of pesticides, etc.), and mechanical practices that foster cycling of resources, promote ecological balance, and conserve biodiversity. Screenings indicated green compost comprised of plant residue as the possible cause of germination problems, wherein the problem is enhanced by the regulations in some EU countries forcing substrate companies to find a replacement for peat, which is considered a non-sustainable product with a high CO₂ footprint. Analysis of the accumulated results by various breeders trough Europe indicated that the higher the percentage of compost, the lower the germination and that the effect is variety related and almost 40% of the seed batches were susceptible to comprised seed germination. Results of seeds tested at high temperature and a stress test in organic substrate indicated the possibility of induced dormancy lined to the use of organic substrates.

Experiments show, that in general the performance of primed and pelleted organic lettuce seed that is sown on substrates that contain compost meets the quality requirements, but that at higher temperatures the performance drops, i.e. higher than 15° C., or higher than 25° C. even when the seed is primed. When lettuce seeds are sown on substrates that do not contain compost, performance at higher temperatures remains good. Furthermore, organic substrate or composts often harbour microorganisms such as filamentous bacteria (bacterial actinomycetes) and/or fungi which, during seed germination and growth of the plant seed on this substrate, may produce and excrete hormones, such as phytohormones, ammonia, affecting seed germination. Tests with seed that were treated with fungicide showed increased germination in comparison to the non-treated seeds, giving food to the thought that the soil contains fungi or excretes from fungi inhibit the germination.

The use of pesticides has been one of the main factors in the rising productivity of agriculture. Also in seed coating use is made of pesticides, such as, for example insecticides and fungicides incorporated in the coatings seeds. However, apart from the fact that many pesticides may affect optimal seed germination, increasing intensified use of chemical products in agriculture is becoming a problem in view of public health and environmental issues related to the use of these chemical products, especially in relation to long-term negative effects. Therefore, organic cultivation is becoming much more a preferred method for cultivation of crops.

Considering the above, there is a need in the art for a coated seed and seed coating that can be used for organic cultivation of seeds, not using chemicals such as pesticides, that improves the seed germination when sown in an organic substrate. In particular there is a need to reduce the negative effects of induced dormancy or (temporal) suppression of germination under the conditions favourable to germination, caused by organic substrate, such as green compost, and/or to adjust/influence the organic priming of the plant seed to avoid reduced seed germination.

It is an object of the present invention, amongst other objects, to address the above need in the art. The object of present invention, amongst other objects, is met by the present invention as outlined in the appended claims.

Specifically, the above object, amongst other objects, is met, according to a first aspect, by the present invention by a plant seed comprising a coating composition for an organically grown plant seed comprised of activated carbon, wherein the coating composition comprises at least 0.5 g activated carbon per 100 g uncoated seed, preferably at least 1 g activated carbon per 100 g uncoated seed, more preferably at least 10 g activated carbon per 100 g uncoated seed, even more preferably at least 50 g activated carbon per 100 g uncoated seed.

Preferably, the present invention provides a plant seed comprising a coating composition for an organically grown plant seed comprised of activated carbon, at least 25 wt % of one or more agent suitable for seed coating, preferably at least 50 wt %, more preferably at least 70 wt %, based on the total weight of the coating composition, wherein the coating composition comprises at least 0.5 g activated carbon per 100 g uncoated seed, preferably at least 1 g activated carbon per 100 g uncoated seed, more preferably at least 10 g activated carbon per 100 g uncoated seed, even more preferably at least 50 g activated carbon per 100 g uncoated seed. The term “agents suitable for seed coating” may comprise “pelleting materials” or “film forming agents” or both.

Uncoated (unpelleted) seeds as used herein refer to plant seeds that do not yet comprise the seed coating, i.e. are not pelleted or filmcoated yet and free from any coating materials, i.e. naked seeds. In a preferred embodiment, the agent suitable for seed coating comprises a pelleting material. Seed pelleting is the process whereby the plant seeds are covered or coated with selected agent to form a shell of pelleting material around the plant seed, thereby providing a pelleted seed. The pelleting material can be applied as a single or multilayer, wherein the activated carbon is comprised in one or more of these layers. The pelleted seed can optionally be further film coated. Coating agents for pelleting, or pelleting materials, are known to the skilled person and comprise a suitable bulking agent such as a clay. The seeds can be coated (pelleted) with pelleting materials such as talc and clay powders are retained onto the seeds, optionally by using binding agents. This pelleting or coating process allows seeds to be more uniformly in size and weight, making them more homogeneous and easier to (mechanically) process, and sow.

According to a preferred embodiment the present invention relates to the plant seed comprising a coating composition, wherein the plant seed comprising the coating composition has a weight ratio of uncoated plant seed to coating composition of at least 1:100 (seed weight:coating composition) to 10:1. Preferable ratios include 5:100, 25:100, 50:100, 1 to 1, 2 to 1, or 4:1. Small, light seeds such as lettuce seeds or radish seed typically comprise a weight ratio of uncoated plant seed to coating composition of at least 1:100 to 50:100, preferably 2:100 to 10:100. Larger seeds typically comprise less coating relative to the total seed weight. For example, a batch of lettuce seeds of about 3.75 gram can be being coated with a coating composition of 96.75 gram (e.g. comprising 93.25 gram of clay and 3.5 gram of activated carbon). The weight ratio of uncoated plant seed to coating composition is 3.9:100.

In another embodiment, the coating composition comprises a film forming agent wherein the film forming agent comprises no polyvinylalcohol (PVA).

Furthermore, and according to the present invention the coating (or pelleting) composition can be loaded with other active ingredients to promote germination and seedling growth. Experiments have shown that the application of active charcoal to pelleted organic plant seed, results in an improved performance, i.e. a performance that meets the quality requirements of the organic grower (no use of chemical pesticides), on substrates that contain compost, also at higher temperatures (>25° C.). The active charcoal is present in the coating of the pelleted seed and is thought to absorb substances present in compost (such as those produced by micro-organisms) which can negatively affect seed germination or other aspects of the performance of the seed. The coating of plant seeds according to the present invention is the practice of covering seeds with external materials to improve handling, protection, germination enhancement of the seed and plant establishment, most preferably germination enhancement of the seed. Furthermore, for uncoated (unpelleted) lettuce seeds, experiments have shown that when seeds are being provided with a coating according to present invention there is an optimum at 70 g activated carbon per 100 g plant seed in view of the enhancement of seed germination. Above 140 g activated carbon per 100 g plant seed, the improved seed germination is being reduced. The coating composition may be a liquid or a powder, preferably a powder for coating of the plant seed.

In an embodiment of present invention, the activated coal is present as a thin layer on a previously untreated (uncoated, naked) seed; the coating composition herein contains no pelleting material and/or film forming agent. In another embodiment, the activated coal is part of a coating composition at least partially covering a seed. The coating composition can further comprise a pelleting material, a film forming agent, or both.

Activated carbon is usually derived from charcoal. Activated carbon may be derived from other carbonaceous source materials such as bamboo, coconut husk, peat, wood, coir, and coal. Activated carbon as used in the composition for coating of present invention may include processed carbon to have small, low-volume pores that increase the surface area available for adsorption. Activated carbon for use according to the invention is preferably in particulate form as powders or fine granules (<1 mm size). A gram of activated carbon can have a specific surface area in excess of 500 m² per g, with 3000 m² being readily achievable.

According to another preferred embodiment, the present invention relates to the plant seed, wherein the one or more agent suitable for seed coating comprises a pelleting material selected from the group consisting of clay, wood fibres, peat, coconut fibre, calcium carbonate, cellulose, or a mixture thereof. Preferably wood fibres and/or clay are selected for seed coating, wherein the composition comprises at least 25 wt % preferably at least 50 wt %, more preferably at least 70 wt %, based on the total weight of the coating composition.

According to another preferred embodiment, the present invention relates to the plant seed, wherein the one or more film forming agents does not comprise polyvinylalcohol (PVA) and is selected from the group consisting of a latex binder and/or a water-soluble polymer, for example xanthan gum. Suitably, emulsion polymers can be obtained as latex binders. A latex is a dispersion of polymeric particles or droplets in liquid. Preferred water-soluble polymers include guar gum, xanthan gum, gum arabic, gum tragacanth, locust bean gum, and agar, gelatin, casein, whey protein.

According to another preferred embodiment, the present invention relates to the plant seed, wherein the one or more agent suitable for seed coating comprises at least 50 wt % of clay with respect to the total weight of the coating composition, and wherein the clay comprises at least one of bentonite, kaolinite, glauconite and/or attapulgite.

According to yet another preferred embodiment, the present invention relates to the plant seed, wherein said clay preferably further comprises one or more selected from the group consisting of hydrous aluminium phyllosilicates, halloysite, lizardite, chrysotile, pyrophyllite-talc, illite, celadonite, vermiculite, montmorillonite, nontronite, saponite, sudoite, clinochlore, chamosite, sepiolite-palygorskite, rectorite, corrensite, tosudite, allophane-imogolite, and mixtures thereof.

According to yet another preferred embodiment, the present invention relates to the composition wherein the composition is free of pesticides, insecticides and herbicides. Organic cultivation required strong reduction or even absence of use of (bio) chemicals or compounds such as pesticides, insecticides and herbicides. But at the same time the composition of present inventions should provide similar or improved the seed germination (i.e. reduced effect of induced dormancy and avoid reduced seed germination), which are also seen with use of chemicals such as pesticides.

According to a preferred embodiment, the present invention relates to the plant seed, wherein said plant seed comprises a coating composition comprising between 0.5 to 10 wt % of activated carbon, preferably between 1 to 5 wt %, more preferably between 2 to 4 wt % based on the total weight of the coated plant seed. Experimental data show that the coated seeds comprising activated carbon in the seed coating have a higher level of seed germination than seeds that do not comprise the activated carbon in the coating when cultivated on organic substrate. The activated carbon (activated charcoal) may serve as absorbent as an absorbent for hormones or phytochemical compounds that are excreted by microorganisms such as fungi or bacterial actinomycetes present in the organic substrate. High levels of activated carbon (i.e. above 10 gram per coated seed) negatively affect seed germination. At low levels, i.e. below 1 gram per coated seed, the absorbant effect will be strongly reduced and the positive effects on seed coating will be more diluted or even absent.

According to a preferred embodiment, the present invention relates to the plant seed, wherein the coating composition comprises a film coating covering the plant seed. A thin film of coating can be provided by spray coating, dipping, fluidised bed, rotary coating or other known film coating techniques suitable for plant seed coating.

According to another preferred embodiment, the present invention relates to the plant seed, wherein the plant seed comprises a coating of the coating composition, wherein said coating comprises at least a first layer comprised of activated carbon, a second middle layer comprised of one or more agents suitable for seed coating, preferably said second middle layer comprises clay, and/or peat, and/or coconut fibre, and/or wood fibre, preferably clay, and optionally a third outer layer comprised of one or more film forming agents. However, it may also be to mix the three compositions and compound making up the first two layer with the base material, i.e. the coating powder and apply the mixture a one layer. The finish layer is usually applied to make the coating more smooth and less dusty.

According to yet another preferred embodiment, the present invention relates to the plant seed, wherein the coating of the seed comprises two or more different layers each having a different release pattern. Each layer may be comprised of compositions having a different function in supporting seed germination and plant growth.

According to another preferred embodiment, the present invention relates to the plant seed, wherein the plant seed is organically grown plant seed. The coating of the plant seed is free of pesticides, insecticides and herbicides; additionally or alternatively seed coating and/or the coated plant seeds are free of a poly(vinyl acetate), a copolymer of vinyl acetate, or another plastic material.

According to a preferred embodiment, the present invention relates to the plant seed, wherein the plant seed is selected from an organically grown plant consisting from the group of lettuce, pepper, tomato, cucumber, melon, spinach, preferably lettuce.

The present invention, according to a further aspect, relates to a plant seed provided with a composition or seed coating of present invention.

The present invention, according to a further aspect, relates to the use of a coating composition for an organically grown plant seed as disclosed above for improving the germination of plant seeds coated therewith, wherein preferably germination is allowed to occur in a agent comprising compost, preferably green compost. Preferably the seed germination of organically cultivated seeds on organic substrate comprising compost are improved by use of the composition of present invention, more specifically in the use of the composition in a seed coating.

According to a preferred embodiment, the present invention relates to the use of a coating composition for an organically grown plant seed, wherein the substrate comprising compost, comprises between 5-80 wt % of compost, preferably between 15 to 40 wt % of compost, and/or at most 5 wt. % peat or turf, preferably wherein the substrate comprising compost is more preferably essentially free of peat and/or turf. The substrate may further contain peat, clay, fibres (such as wood fibres and/or coconut fibres), sand, lava and auxiliary components such as nutrients.

Preferably the substrate contains compost and fibrous material preferably selected from the group consisting of wood fibres, wood chips, coconut fibres, and rice husks wherein the compost and the fibrous material together make up for at least 25% of the total weight of the substrate. The total amount of peat, clay, sand, fibres, compost and auxiliary compounds is 100%. The substrate preferably contains less than 80% peat, more preferably less than 70%, 60%, 50%, 40%, 30%, 20%, 10% or 5% peat relative to the total weight of the substrate. Preferably the substrate contains no peat.

The present invention, according to a further aspect, relates to a method for coating of plant seeds with a composition or seed coating of present invention as described above, wherein the plant seed is covered with said composition of coating.

According to a preferred embodiment, the present invention relates to the method for coating of plant seeds, wherein said covering of seeds is achieved by spray coating, dipping, fluidised bed, rotary coating, dusting on naked seeds or powdering the plant seeds. Preferably the plant seeds are sprinkled with the powder comprised of the coating composition as disclosed above thereby coating the plant seed.

The present invention, according to a further aspect, relates to a method for improved seed germination of organically grown plant seeds, wherein said seeds are covered or coated with a composition or seed coating of present invention as described above. The method wherein the seeds are being coating or covered with the composition or seed coating of present invention, improves the seed germination of organically cultivated seeds on organic substrate comprising compost. The method is free of pesticides, insecticides and herbicides and at the same time provide improved the seed germination, a reduced effect of induced dormancy which are observed with the use of chemicals such as pesticides.

According to a preferred embodiment, the present invention relates to the method, wherein said covering of plant seeds is achieved by
dusting the plant seeds with activated carbon and coating the dusted seeds in the presence of a powdery clay-based material under intermittent spraying with water, or
coating the plant seeds using a powdery mixture comprising a composition as disclosed herein, under intermittent spraying with water, wherein the obtained coated plant seeds optionally receive a finish layer. Said covering can be achieved by applying a film-forming liquid coating composition of present invention comprising activated carbon or wherein said covering is achieved by dusting the seeds with activated carbon following which the dusted seeds are provided with a layer of a film-forming liquid coating composition.

The present invention, according to a further aspect, relates to the use of activated carbon for improving the germination of plant seeds coated therewith, wherein preferably germination is allowed to occur in a substrate comprising compost, preferably green compost.

The present invention will be further detailed in the following examples and figures wherein:

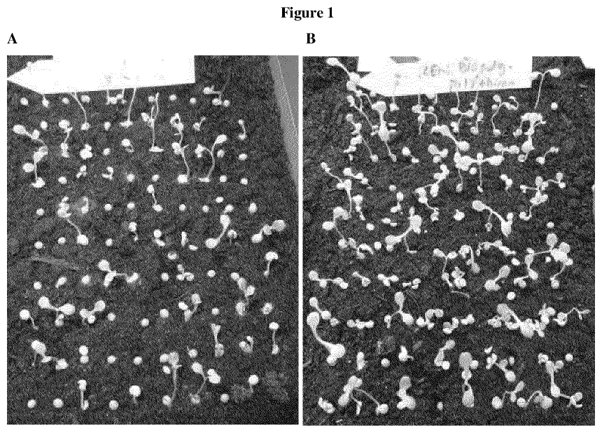

FIG. 1: shows seed germination of lettuce seed on organic substrate comprising compost (Klasmann bio substrate) in response to thiram treatment. Seeds grown on organic substrate and treated with thiram (FIG. 1A) showed about 85% germination, whereas of the untreated seeds (FIG. 1B) on organic substrate only about 25% germinated.

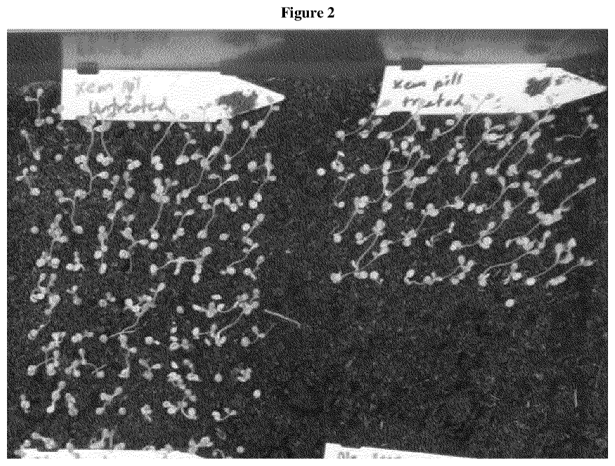

FIG. 2: shows the germination of lettuce seeds treated with thiram and grown on pure peat (left) and untreated lettuce seeds (right, only 50 seeds were sown). The germination of the seeds in both groups were compatible, i.e. about 99% seed germination further indicating that the organic substrate comprising (green) compost seem to be the factor involved in the observed reduced seed germination.

### EXAMPLES

### Effect of Organic Substrate on Germination of Lettuce Seed

Organic lettuce seed of six different varieties were tested in this trial wherein 100 seeds were grown with organic substrate Klasmann or pure peat.; Alborada, Marcord, Xalbadora, Ovired, and Olana. Primed and pelleted seeds were germinated at the germination lab using as substrate pure peat or using organic substrate (Klasmann bio substrate receipt). The Klasmann substrate comprises 20% green compost, and is kept in a closed container in cold conditions, refrigerator at 7° C. Sowing of the seeds was done directly on cold substrate and then grown with no cover layer and directly incubated in chamber at 25° C. Six days after sowing, the germination level was determined (Table 1).

TABLE 1
Germination levels lettuce seeds

| | Germination level | Germination level |
|---|---|---|
| Variety | pure peat substrate | organic substrate |
| Alborada | 99% | 98% |
| Marcord | 99% | 97% |
| Xalbadora | 99% | 96% |
| Ovired | 99% | 86% |
| Olana | 99% | 78% |

The seed germination on pure peat substrate were all good as expected, almost all seeds germinated in all lettuce varieties. In the germination test with organic substrate, the Ovired and Olana varieties showed to be affected in germination. Alborada, Marcord, and Xalbadora showed no influence on the organic substrate.

### Effect of Fungicide on Seed Germination of Lettuce Seed in Organic Substrate

The above experiment indicates that various lettuce seeds have problems when germinated in organic substrates and indicated the green compost as the possible cause. The estimation is that problems might increase since the regulations in some EU countries forces substrate companies to find a replacement for peat, a non-sustainable product with a high CO₂ footprint. The higher the percentage of compost in the organic substrate, the lower the level of seed germination is. Abnormalities found during germination in such stress conditions by organic substrate are indicating towards aging or physiologic stress induced by hormones excreted by microorganisms such as fungi (cf. Fusarium) or bacterial actinomycetes, and the possibility of induced dormancy induced by the green compost and/or the microorganisms in the substrate. To test the factor involved in the germination reduction, lettuce seed germination was tested in organic substrate (Klasmann) and pure peat substrate, with and without fungicide (thiram, 8 μg).

Seed germination showed clear response to thiram treatment, see FIG. 1. Seeds grown on organic substrate and treated with thiram (FIG. 1A) showed about 85% germination, whereas of the untreated seeds (FIG. 1B) on organic substrate only about 25% germinated. FIG. 2 shows the germination of the seeds on pure peat with (left) and without (right, here only 50 seeds were sown) thiram, where seed germination was comparable between the two groups with about 99% seed germination.

### Effect of Activated Carbon on the Germination Level of Lettuce Seed

Primed and pelleted lettuce seeds (100) of four varieties (Jara, Tregpney, Aferdita and Orane) were sown on organic substrate (Klasmann) or pure peat and seeds were germinated at the germination lab as described above. The seeds have been pelleted in a rotating pan in the presence of standard clay-based pellet material or with the same clay-based pellet material containing 2.5 gram of activated carbon per 100 g pelleted seed amounting to 66 g of activated carbon per 100 g untreated seed. The activated carbon was obtained ex Merck, CAS #7440-44-0. Hereby the dry, powdered pellet material was added to the seeds under rotation of the pan and under addition of water to allow the powdered material to agglomerate onto the seeds to form pelleted seeds. After the pelleting process, the pelleted seeds were dried.

TABLE 2
Germination levels on pure peat substrate
with/without activated carbon (AC).

| Variety | No AC | AC |
|---|---|---|
| Jara | 99% | 98% |
| Tregpney | 100% | 99% |
| Aferdita | 97% | 93% |
| Orane | 73% | 90% |

TABLE 3
Germination levels on organic substrate
with/without activated carbon (AC)

| Variety | No AC | AC |
|---|---|---|
| Jara | 96% | 91% |
| Tregpney | 96% | 98% |
| Aferdita | 75% | 95% |
| Orane | 3% | 84% |

Lettuce seeds comprising a seed coating comprising activated carbon showed improved seed germination. Especially lettuce varieties such as Orane, which already show decreased germination levels at nonorganic standard substrate (pure peat) and a coating not comprising activated coal (73%), resulted in an improved germination level when activated carbon was present in the seed coating (90%). This result is even more pronounced when Orane is germinated on organic substrate, where only 3% of the seeds germinated in the absence of activated carbon and dramatically increased to 84% seed germination in case activated carbon was present in the seed coating.

Furthermore, to test the effect of the concentration of activated carbon on the lettuce seeds, two varieties (Tregpney and Aferdita) were sown on organic substrate (Klasmann) and seeds were germinated at the germination lab as described above. The seeds have been pelleted using a standard clay-based pellet material or with the same clay-based pellet material containing activated carbon in increasing amount (activated charcoal powder, Merck CAS #7440-44-0) according to the composition of present invention comprising 0, 1, 2, 5 or 5 wt % of activated carbon, based on the total weight of the pelleted seed.

TABLE 3
Germination levels on organic substrate.

| Activated carbon in | | |
|---|---|---|
| seed coating (wt %) | Treqpney | Aferdita |
| 0 | 91% | 67% |
| 1 | 97% | 88% |
| 2.5 | 99% | 93% |
| 5 | 92% | 89% |

Results show that the seeds comprising the activated carbon in the pelleted seed have a higher level of seed germination that seeds that do not comprise the activated carbon in the coating. Most likely the activated carbon functions as an absorbent for hormones or phytochemical compounds that are excreted by microorganisms such as fungi or bacterial actinomycetes present in the organic substrate. However adding too much activated carbon, the coating composition seems to negatively affect seed germination as well (e.g. at levels higher than 5 wt % of activated carbon with respect to the total weight of the seed.

1. A plant seed comprised of a coating composition for an organically grown plant seed comprising activated carbon, and at least 25 wt %, preferably at least 50 wt %, more preferably at least 70 wt % of one or more agents suitable for seed coating, based on the total weight of the coating composition, and optionally one or more film-forming agents, wherein the one or more agents suitable for seed coating is selected from the group consisting of clay, wood fibres, peat, coconut fibre, calcium carbonate, cellulose, or a mixture thereof, wherein the coating composition comprises at least 10 g activated carbon per 100 g uncoated plant seed, even more preferably at least 50 g activated carbon per 100 g uncoated plant seed

2. The plant seed according to claim 1, wherein the one or more film forming agents does not comprise polyvinylalcohol (PVA) and is selected from the group consisting of a latex binder and/or a water-soluble polymer, for example xanthan gum.

3. The plant seed according to claim 1, wherein the one or more agents suitable for seed coating comprises at least 50 wt % of clay with respect to the total weight of the coating composition, and wherein the clay comprises at least one of bentonite, kaolinite, glauconite and/or attapulgite.

4. The plant seed according to claim 3, wherein said clay preferably further comprises one or more selected from the group consisting of hydrous aluminium phyllosilicates, halloysite, lizardite, chrysotile, pyrophyllite-talc, illite, celadonite, vermiculite, montmorillonite, nontronite, saponite, sudoite, clinochlore, chamosite, sepiolite-palygorskite, rectorite, corrensite, tosudite, allophane-imogolite, and mixtures thereof.

5. The plant seed according to claim 1, wherein the coating composition is free of pesticides, insecticides and herbicides.

6. The plant seed according to claim 1, wherein said plant seed comprises between 0.5 to 10 wt % of activated carbon, preferably between 1 to 5 wt %, more preferably between 2 to 4 wt % based on the total weight of the coated plant seed.

7. The plant seed according to claim 1, wherein the coating composition comprises a film coating covering the seed.

8. The plant seed according to claim 1, wherein the plant seed comprises a coating of the coating composition, wherein said coating comprises at least a first layer comprised of activated carbon, a second middle layer comprised of one or more agents suitable for seed coating, preferably said second middle layer comprises clay, and/or peat, and/or coconut fibre, and/or wood fibre, preferably clay, and optionally a third outer layer comprised of one or more film forming agents.

9. The plant seed according to claim 1, wherein the plant seed is an organically grown plant seed.

10. The plant seed according to claim 1, wherein the plant seed is from an organically grown plant consisting from the group of lettuce, pepper, tomato, cucumber, melon, preferably lettuce.

11. Use of a coating composition for an organically grown plant seed as disclosed in claim 1 for improving the germination of plant seeds coated therewith, wherein preferably germination is allowed to occur in a substrate comprising compost, preferably green compost.

12. The use according to claim 11, wherein the substrate comprising compost, comprises between 5-80 wt % of compost and/or at most 5 wt. % peat or turf, preferably wherein the substrate comprising compost is essentially free of peat and/or turf.

13. A method for coating of organic plant seeds with a coating composition for an organically grown plant seed as disclosed in claim 1, wherein the plant seed is covered with said composition or coating.

14. A method for coating of organic plant seeds with a coating composition for an organically grown plant seed, wherein the plant seed is covered with said composition or coating, wherein said covering of plant seeds is achieved by
dusting the plant seeds with activated carbon and coating the dusted seeds in the presence of a powdery clay-based material under intermittent spraying with water, or
coating the plant seeds using a powdery mixture comprising a coating composition for an organically grown plant seed as disclosed in claim 1, under intermittent spraying with water,
wherein the obtained coated plant seeds optionally receive a finish layer.

15. Use of activated carbon for improving the germination of plant seeds coated therewith, wherein preferably germination is allowed to occur in a substrate comprising compost, preferably green compost.
